(19) United States
(12) Patent Application Publication
(10) Pub. No.: US 2001/0055035 A1
(43) Pub. Date: Dec. 27, 2001

(54) Image processing method and system using computer graphics

(76) Inventor: Naoto Kinjo, Kanagawa (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/828,474

(22) Filed: Apr. 9, 2001

(30) Foreign Application Priority Data
Apr. 7, 2000 (JP) 2000-106126
Apr. 7, 2000 (JP) 2000-106823

(51) Int. Cl. G06T 17/00; G09G 5/02

(52) U.S. Cl. 345/698; 345/428

(57) ABSTRACT

The image processing method and system utilizing computer graphics form a computer graphics image by a computer graphics algorithm at a particular drawing level selected from a plurality of drawing levels set in advance for the computer graphics algorithm based on at least one of an amount of computation processing, an amount of data and a display resolution, and performing processing at a higher drawing level than the particular drawing level based on editing data in the process of forming the computer graphics image at the particular drawing level and attached data thereby forming image data at the higher drawing level. The image processing method reads a hand-drawn image, extracting from the hand-drawn image a figure having a shape registered in advance, and substituting an image registered in advance and corresponding to the extracted figure for the extracted figure in the read hand-drawn image thereby forming an output image.

### BACKGROUND OF THE INVENTION

1. Field of the Invention

The present invention relates to an image processing method and system for obtaining a high-quality print or a displayed image from an image formed by using computer graphics (CG) techniques, and to an image processing method for forming an output image from a hand-drawn input image or the like by using computer graphics.

2. Description of the Related Art

In recent years, remarkable advances have been made in computer graphics for drawing a picture with a computer, and improved computer graphics have been widely used in various fields, e.g., in the fields of illustration, computer-aided design (CAD), games, car navigation, flight simulation, and special effects for movies, commercials, etc. For example, the process of preparing digital image data by computer graphics, processing the digital image data, and outputting a print of the processed image data is being practiced as well as processing of digital image data supplied from a digital camera, a scanner or the like.

When a three-dimensional image is formed by computer graphics, the three-dimensional shape of the image is approximated by polygons (polygonal facets) and the three-dimensional positions of the apices of each polygon and the vertices of at which the surfaces or ridge lines of combined polygons meet are represented by coordinates. The amount of data defined in this manner is considerably large. Therefore it is desirable to reduce the number of polygons and various methods for doing so have been proposed.

For example, a method of optimizing the number of drawn polygons according to the ability and the display size of a processor is described in “Development of Adaptive 3DCG Display System” (Masatoshi Arai, Interface, February 2000). In this method, an original polygon model for approximation of a three-dimensional object is divided into a basic polygon model and metadata; the basic polygon model is shaped; animation data is formed; display parameters relating to image qualities, etc., according to the machine performance are input to compute an optimum number of polygons; and the resulting image is displayed with the optimum number of polygons according to the conditions of the machine, thus realizing efficient display.

However, there are image processing methods which depend upon techniques other than those for the above-described polygon modeling with respect to some kinds of scenes imaged and, therefore, the range of application of methods based on the above-described conventional polygon drawing is limited.

Other various methods for forming images by using computer graphics have also been proposed. For example, a method relating to simplification of computer graphics image drawing operations based on handdrawing is described in “Teddy, Three-dimensional Modeling by Handwriting” (Takeo Igarashi, Bit, pp.43-48, February 2000).

This method achieves automatic three-dimensionalization to enable ordinary users to easily form a three-dimensional computer graphics image without complicated operations such as using combinations of enormous number of commands and finely designating the positions of a multiplicity of control points.

This method and other conventional computer graphics image forming methods are intended to easily form a computer graphics image by handdrawing. However, each of the conventional methods requires inputting image data through a personal computer with a mouse, an electronic pad, or the like, which cannot be regarded as easy for anybody to perform, and which is difficult for persons weak in handling a computer or for children.

### SUMMARY OF THE INVENTION

In view of the above-described problems of the conventional art, an object of the present invention is to provide an image processing method and system which utilize computer graphics to obtain a high-quality print or a high-grade output image, a high-grade display image, for example, in such a manner that computer graphics editing is efficiently performed according to the mechanical performance of a computer such as a personal computer.

Another object of the present invention is to provide an image processing method which enables a person weak in handling a computer to easily form a computer graphics image and to output a hand-drawn image as an output image by using computer graphics.

In order to attain the first object described above, the first aspect of the present invention provides an image processing method utilizing computer graphics in which an image at a higher drawing level is formed from a computer graphics image formed by computer graphics, the method comprising the steps of: selecting a particular drawing level from a plurality of drawing levels set in advance for a computer graphics algorithm based on at least one of an amount of computation processing, an amount of data and a display resolution; executing a process of forming the computer graphics image by the computer graphics algorithm at the thus selected particular drawing level; and performing processing by the computer graphics algorithm at a higher drawing level than the particular drawing level which was selected from the plurality of drawing levels based on editing data in the process of forming the computer graphics image at the particular drawing level or based on the editing data and attached data thereby forming image data at the higher drawing level.

Preferably, the image at the higher drawing level is an image to be printed or an image to be displayed, and the image data at the higher drawing level is print image data or display image data.

Preferably, the image at the higher drawing level is an output image, the image data at the higher drawing level is output image data, and the processing by the computer graphics algorithm at the higher drawing level is performed in a process of outputting.

When the computer graphics image is formed, the particular drawing level is preferably selected from the plurality of drawing levels for each image component in an imaged scene or for each processing operation performed for producing a specified particular effect on the computer graphics image.

Preferably, a plurality of computer graphics algorithms are further prepared, and a particular algorithm is selected from the plurality of computer graphics algorithms based on at least one of the amount of computation processing, the amount of data and the display resolution, and for the thus selected particular algorithm, the particular drawing level is selected from the plurality of drawing levels.

When the computer graphics image is formed, the particular algorithm is preferably selected from the plurality of computer graphics algorithms for each image component in an imaged scene or for each processing operation performed for producing a specified particular effect on the computer graphics image.

Preferably, the process of forming the computer graphics image at the particular drawing level is performed in a first image processor, whereas the processing by the computer graphics algorithm at the higher drawing level is performed with a different timing in a second image processor different from the first image processor.

Preferably, the first image processor is a personal computer and the second image processor is a host computer connected to the personal computer through a communication network.

Preferably, the process of forming the computer graphics image at the particular drawing level is performed in an image processor and the processing by the computer graphics algorithm at the higher drawing level is performed in the same image processor.

Preferably, the image processor is a personal computer.

Preferably, processing operations at different drawing levels including the process of forming the computer graphics image at the particular drawing level and the processing by the computer graphics algorithm at the higher drawing level are performed by sharing among a plurality of image processors interconnected through a communication network.

Preferably, the plurality of image processors are personal computers.

Preferably, an image processor to be selected from the plurality of image processors for performing a processing operation at each of the different drawing levels and a timing applied for performing the processing operation are set in advance to the editing data or as a processing condition.

In order to attain the first object described above, the second aspect of the present invention provides an image processing system utilizing computer graphics comprising: a host computer; and an image processor which is connected to the host computer through a communication network and forms a computer graphics image for forming an output image in the host computer, the image processor including: a selecting section for selecting for a computer graphics software a particular algorithm and a particular drawing level from a plurality of algorithms and a plurality of drawing levels set in advance in the host computer based on at least one of an amount of computation processing, an amount of data and a display resolution; a download section for downloading the computer graphics software corresponding to the thus selected particular algorithm and drawing level from the host computer; and an image forming section for forming the computer graphics image by using the thus downloaded computer graphics software; wherein image editing data in a process of forming the computer graphics image or the image editing data and data attached thereto are transmitted to the host computer through the communication network.

In order to attain the first object described above, the third aspect of the present invention provides an image processing system utilizing computer graphics comprising: an image processor; and a host computer which forms an output image based on a computer graphics image formed in the image processor connected to the host computer through a communication network; the host computer including: a selecting section for selecting a computer graphics software at a higher drawing level than in a computer graphics software used by the image processor to form the computer graphics image; and a section for forming the output image by the selected computer graphics software at the higher drawing level by using image editing data when the computer graphics image was formed in the image processor or the image editing data and data attached thereto, which have been received from the image processor through the communication network; wherein the output image is output as a print, recorded on a predetermined recording medium, or transmitted through the communication network.

In order to attain the first object described above, the fourth aspect of the present invention provides an image processing system utilizing computer graphics comprising; a first image processor for forming a computer graphics image; and a second image processor for forming an output image based on the computer graphics image formed in the first image processor; wherein the first image processor includes: a selecting section for selecting for a computer graphics software a particular algorithm and a particular drawing level from a plurality of algorithms and a plurality of drawing levels set in advance in the second image processor based on at least one of an amount of computation processing, an amount of data and a display resolution; and a computer graphics image forming section for forming the computer graphics image by using the computer graphics software corresponding to the thus selected particular algorithm and drawing level, whereas the second image processor includes: a selecting section for selecting a computer graphics software at a higher drawing level than in the computer graphics software used in the first image processor to form the computer graphics image; and a section for forming the output image by the thus selected computer graphics software at the higher drawing level by using image editing data when the computer graphics image was formed in the first image processor or the image editing data and data attached thereto; and wherein the output image is output as a print, recorded on a predetermined recording medium, or transmitted through a communication network.

Preferably, the first image processor is connected to the second image processor through the communication network; the first image processor further includes a download section for downloading the selected computer graphics software from the second image processor; the computer graphics image forming section forms the computer graphics image by using the computer graphics software downloaded by the download section; the image editing data when the computer graphics image was formed or the image editing data and the data attached thereto are transmitted to the second image processor through the communication network; and the second image processor receives the image editing data when the computer graphics image was formed or the image editing data and the data attached thereto from the first image processor through the communication network.

Preferably, the second image processor is a host computer connected to the first image processor through the communication network.

Preferably, one image processor functions as the first image processor and the second image processor.

Preferably, the first image processor is a personal computer.

Preferably, the first image processor and the second image processor include a plurality of personal computers which execute the computer graphics software in different algorithms included in the plurality of algorithms and at different drawing levels included in the plurality of drawing levels; the plurality of personal computers are interconnected by the communication network, and the computer graphics software is shared for the different algorithms and the different drawing levels among the plurality of personal computers and executed.

Preferably, a personal computer to be selected from the plurality of personal computers for executing the computer graphics software in each of the different algorithms and at each of the different drawing levels, and a timing applied for executing the computer graphics software are set in advance to the editing data or as a processing condition.

In order to attain the second object described above, the fifth aspect of the present invention provides an image processing method comprising the steps of: reading a hand-drawn image; extracting from the thus read hand-drawn image a figure having a shape registered in advance; and substituting an image registered in advance and corresponding to the thus extracted figure for the extracted figure in the read hand-drawn image thereby forming an output image.

Preferably, the image registered in advance is a computer graphics image or a photographic image.

In order to attain the second object described above, the sixth aspect of the present invention provides an image processing method having at least one mode corresponding to a figure having a shape registered in advance which is selected from: a mode in which a complete computer graphics image is registered in advance; a mode in which computer graphics forming algorithms and setting parameter editing data are registered in advance; and a mode in which the complete image and the editing data are selectively registered, the method comprising the steps of: reading a hand-drawn image; extracting from the thus read hand-drawn image the figure having the shape registered in advance; and forming an output image by substituting for the extracted figure the complete image registered in advance and corresponding to the extracted figure, or by forming a computer graphics image by using the editing data registered in advance and corresponding to the extracted figure and by substituting the formed computer graphics image for the extracted figure according to one of the modes.

Preferably, switching between the mode for registering the complete image and the mode for registering the editing data is performed according to a frequency of use of a registered image, or a composition or an image quality of the output image.

### BRIEF DESCRIPTION OF THE DRAWINGS

FIG. 1 is a block diagram schematically showing the configuration of an embodiment of the image processing system of the present invention with which the image processing method according to the first aspect of the present invention is carried out to form a print and the like;

FIG. 2 is a flowchart showing the operation of a first embodiment of the first aspect of the present invention;

FIG. 3 is a diagram showing an example of image processing in the first embodiment shown in FIG. 2;

FIG. 4 is a flowchart showing the operation of a second embodiment of the first aspect of the present invention;

FIG. 5 is a block diagram schematically showing the configuration of another embodiment of the image processing system according to the present invention;

FIG. 6 is a block diagram schematically showing the configuration of a further embodiment of the image processing system according to the present invention;

FIG. 7 is a block diagram schematically showing the configuration of a digital photoprinter including an image processor for carrying out the image processing method in the fifth aspect of the present invention;

FIG. 8A is a diagram showing an example of a handdrawn image in a fifth embodiment of the present invention;

FIG. 8B is a diagram showing an example of a computer graphics image formed from the hand-drawn image shown in FIG. 8A;

FIGS. 9A and 9B are diagrams respectively showing an example of a hand-drawn image and a corresponding computer graphics image in a sixth embodiment of the present invention;

FIGS. 10A and 10B are diagrams respectively showing another example of the hand-drawn image and the corresponding computer graphics image in the sixth embodiment of the present invention;

FIG. 11A is a diagram showing a hand-drawn image in a seventh embodiment of the present invention; and

FIG. 11B is a diagram showing an example of a computer graphics image formed from the hand-drawn image shown in FIG. 11A.

### DESCRIPTION OF THE PREFERRED EMBODIMENTS

An image processing method and system using computer graphics in accordance with the present invention will be described in detail with reference to the accompanying drawings.

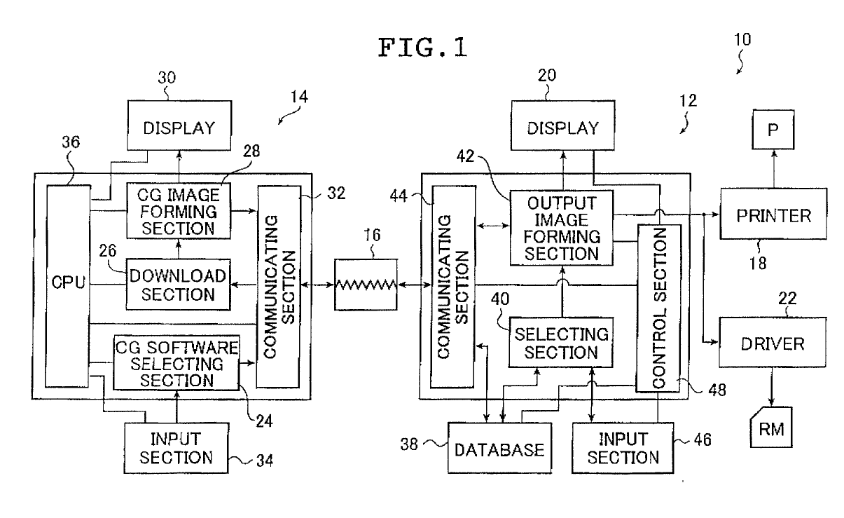

An image processing method using computer graphics in the first aspect of the present invention and an image processing system in the second, third and fourth aspects of the present invention will first be described with reference to FIGS. 1 through 6.

FIG. 1 schematically shows an embodiment of the image processing system in the second, third and fourth aspects of the present invention, through which the image processing method using computer graphics in the first aspect of the present invention is carried out to form an output image such as an image to be printed or displayed.

In an image processing system 10 shown in FIG. 1, a customer's terminal 14 is connected to a host computer 12 in a laboratory via a communication network 16 such as the Internet. A printer 18 for outputting a Photographic print (hereinafter referred to simply as “print”) P of an image formed for prints is connected to the host computer 12. In the laboratory, as output images, an image to be displayed may be formed as well as an image to be printed and then displayed on a display 20, data of the image to be printed or displayed may be output to a predetermined recording medium RM by a driver 22, and the image data may be sent back or delivered to the customer's terminal 14, any other destination or delivery address or the like via the communication network 16.

The customer's terminal 14 is a first image processor with which the customer forms a computer graphics image by using computer graphics, and which may be a personal computer, a game machine having predetermined functions, or a personal digital assistant (PDA), and is not limited to a particular device or machine. Any processor may suffice as the customer's terminal 14 if a computer graphics editing software (hereinafter referred to as “CG software”) can be downloaded from the host computer 12 and the customer can form a computer graphics image (hereinafter referred to as “CG image”) with the CG software, and if the customer can send image editing data obtained upon forming of CG images or such image editing data and its annex data (attached data) s well to the host computer 12 via the communication network 16.

The terminal 14 comprises a CG software selecting section 24 for accessing the host computer 12 via the communication network 16 and selecting the CG software having a specified algorithm and a specified drawing level from the CG software having a plurality of algorithms and a plurality of drawing levels previously set in the host computer 12 on the basis of at least one of following factors: the amount of computation processing, the amount of data and the display resolution, and stored in a database 38; a download section 26 for downloading the CG software selected in the CG software selecting section 24 from the database 38 of the host computer 12 and stores it in its inner memory; a CG image forming section 28 where a CG image is formed using the CG software downloaded into the memory in the download section 26; a display 30 on which is displayed a CG image being edited or having been formed in the CG image forming section 28; a communicating section 32 by means of which various types of CG software having respective levels, various data such as image editing data of CG images and annex data thereof, various image data or the like are sent to the host computer 12 or received from it via the communication network 16; an input section 34 where various data, selection information, instructions or the like are inputted; and a control section (CPU) 36 which performs the control and the like of the entire terminal including those components as above.

On the other hand, the host computer 12 is a second image processor for forming an output CG image of higher drawing level than the CG image formed by the customer to output it as a high-quality print P, for example. The host computer 12 comprises the database 38 where the CG software having a plurality of algorithms and a plurality of drawing levels, or various image data or any other data are stored; a selecting section 40 for selecting the CG software having a drawing level at least higher than that of the CG software used for forming of CG images in the terminal 14; an output image forming section 42 where a high-grade output image such as an image to be printed or displayed is formed with the CG software of a higher drawing level selected in the selecting section 40, using image editing data obtained when CG images have been formed in the terminal 14 or such image editing data and its annex data as well received from the terminal 14 via the communication network 16; a communicating section 44 by means of which various types of CG software having respective levels, various data such as image editing data of CG images and annex data thereof, various image data or the like are sent to the terminal 14 or received from it via the communication network 16; an input section 46 where various input operations such as data inputting, selection information inputting and instruction inputting are performed; and a control section (CPU) 48 which performs the control and the like of the entire host computer including those components as above

As stated before, to the host computer 12 as shown are connected the printer 18 for outputting a high-grade output image formed In the output image forming section 42 on the basis of image data for prints as a high-quality print P; the display 20 on which is displayed a CG image being edited or having been formed in the output image forming section 42 on the basis of image data for display; and the driver 22 for recording on a specified recording medium RM and outputting the recording medium RM on which recording has been already performed. The host computer 12 as shown may also send or deliver such image data as above to the customer's terminal 14, any other destination or delivery address or the like via the communication network 16, as stated before.

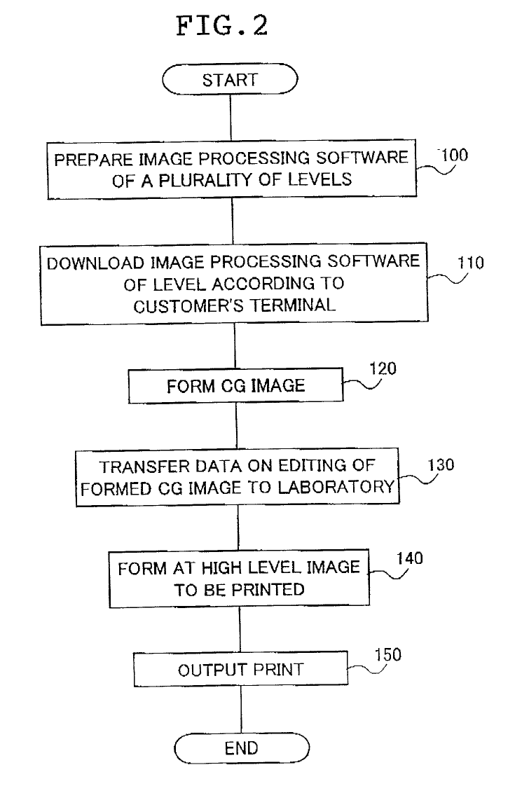

The operation of the first embodiment of the present invention will now be described with reference to the flowchart of FIG. 2.

Firstly in step 100, regarding the level of image forming based on computer graphics (hereinafter referred to simply as “CG”), the CG software having a plurality of levels with respect to each of a plurality of CG algorithms is previously prepared on the laboratory side on the basis of at least one of the factors: the amount of computation processing, the amount of data, and the display resolution and set in the database 38 of the host computer 12.

This is intended to set a plurality of levels of setting and processing relating to the reality of drawing in terms of the resolution, the number of polygons, raying processing, etc., or density scale resolution, the existence/nonexistence of reflected light, etc., in other words, a plurality of image drawing or image expression levels or “drawing levels” or “expression levels”. Such levels are typically designated as “drawing levels” in the present invention.

A plurality of drawing levels are set on the basis of the amount of computation processing, the amount of data, and the display resolution, and the CG image processing software, namely the CG software, constituted at respective drawing levels is prepared corresponding to each of a plurality of CG algorithms and stored in the database 38.

Secondly in step 110, at a request from the input section 34 of the customer's terminal 14, the host computer 12 in the laboratory is accessed and the CG algorithm at a specified drawing level which is selected by the customer from a plurality of drawing levels set in the database 38 of the computer 12, ordinarily a low drawing level, is selected by the selecting section 24 and the selected CG algorithm at a specified drawing level is downloaded by the download section 26 to the memory in the section 26 of the terminal 14 via the communication network 16 such as the Internet.

As mentioned above, the customer's terminal 14 may be a personal computer, a game machine, a PDA, or the like. At this time, the host computer 12 in the laboratory may determine the CG image processing software of the suitable drawing level according to the performance of the CG image forming section 28, the central processing unit (CPU) 36, the display device such as the display 30, etc. of the customer's terminal 14 and send the software to the customer's terminal 14 via the communication network 16.

In step 120, the customer forms a CG image through the CG image forming section 28 in the terminal 14 by using the CG algorithm at the particular drawing level downloaded to the download section 26.

In step 130, the customer sends data on image editing upon forming of the CG image at the particular drawing level or a set of the image editing data and the data attached thereto to the host computer 12 in the laboratory via the communication network 16 and requests the laboratory to print an image on the basis of the sent data. The attached data sent by the customer together with the image editing data is, for example, image data obtained by scanning an original photograph which the customer wishes to superimpose on the computer graphics image. Data on order contents, such as a print size, the number of prints, the due date of receipt, a place designation, recording on a recording medium, and return of image data prepared in the laboratory may be sent as order information. If the same order contents will be sent to the laboratory every time, they may be registered in the laboratory after being sent to the laboratory at a time.

Next, in step 140, the host computer 12 in the laboratory selects with its selecting section 40 the CG software having the CG algorithm at the drawing level higher than the particular drawing level of the CG image processing software used by the customer and uses this CG software of the higher drawing level to form at a higher drawing level a high-quality output image such as CG images to be printed or displayed on the basis of the image editing data obtained upon forming of the CG image or such data and its annex data which are sent from the customer's terminal 14.

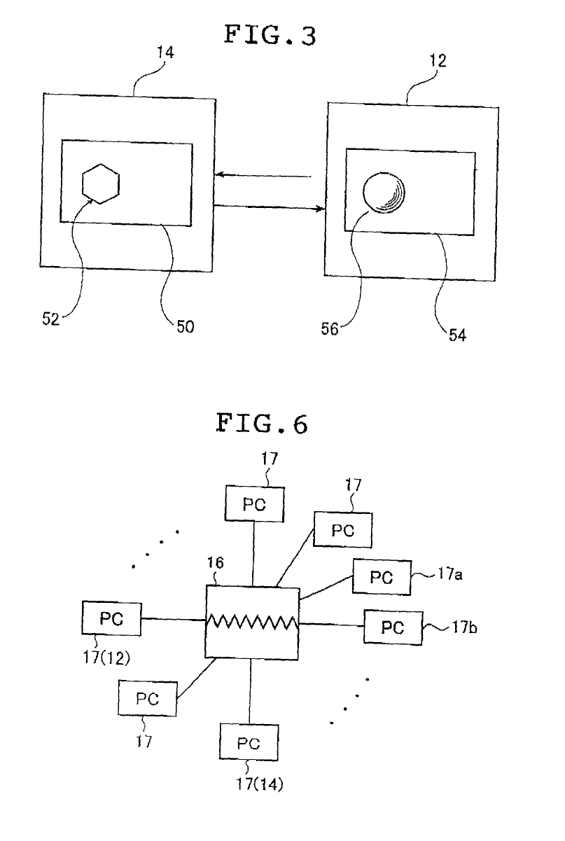

FIG. 3 shows an example of images processed in the above-described process. The customer draws a picture containing an image of a ball by operating the terminal 14 such as a personal computer. Since the level of the CG image processing software used in the customer's terminal 14 is low, and since primary importance is attached to the processing speed, a corresponding ball 52 in an image 50 formed by the customer is expressed as a rough polygon without shading, as shown in FIG. 3. Further, the customer designates image editing data for drawing the ball, e.g., data on the shape, the position in the image, the size, and the color of the ball, the direction of rays, etc., and transmits this image editing data to the laboratory. In the laboratory, a precise image of a ball 56 in an image 54 is formed at a higher drawing level on the basis of the received image editing data such as to faithfully express the original ball.

In step 150, if the order from the customer is a request for forming a print, an image to be printed is formed in the laboratory and is output as a print P from the printer 18 connected to the host computer 12.

In this embodiment, as described above, an image is formed in the laboratory at a drawing level higher than that of the corresponding image displayed on the customer's terminal, thus enabling a shaded fine picture to be drawn and output as a high-quality print P or the like. Naturally, in host computer 12, the recording medium RM on which the output image data making it possible to form an output image to be printed with high-quality is recorded may be output from the driver 22, or such high-grade output image data may be sent or delivered to the customer's terminal 14, any other destination or delivery address via the communication network 16.

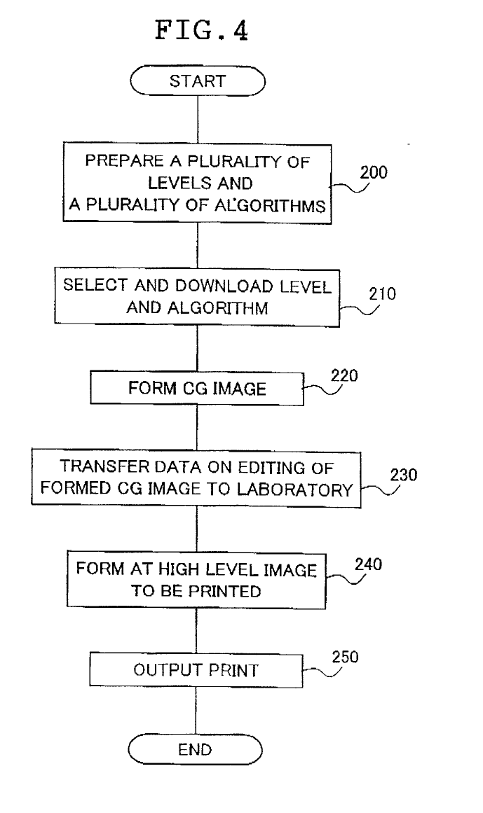

A second embodiment of the present invention will next be described with reference to the flowchart of FIG. 4.

In step 200 shown in FIG. 4, an image processing software having a plurality of drawing levels is prepared in the host computer 12 in the laboratory, as in the first embodiment. At this time, as a CG software itself is prepared that having a plurality of algorithms, e.g., an algorithm provided from a maker A, an algorithm provided from a maker B, etc.

In step 210, the customer selects any of the algorithms for forming of CG and a particular drawing level of the image processing software using the selected algorithm, and then downloads the image processing software to the customer's terminal 14 via the communication network 16.

However, the selection in this step differs from that in the first embodiment in that the customer can select particular algorithms and drawing levels with respect to the components of an image or different kinds of special-effect processings performed on the components.

Examples of the components of an image are a human figure (in more detail, the skin, the hair, etc.), clothes, a rigid structure, such as a building, a tree, a cloud, a fluid, such as water, and a texture of wood, a metal, a plastic or the like in the surface of an object.

Examples of special-effect processing are shading processing for expressing a state of an object irradiated with light falling directly on the surface of the object, with reflected light, or with a combination of direct and reflected light, processing for a simulation of a physical phenomenon such as a fall or impingement of an object, and processing for an oil-painting or watercolor-painting finish. One of these kinds of special-effect processings may be performed exclusively on one component, on several components, or on the entire image.

Therefore, the drawing level may be selected in such a manner that a human figure is finely expressed at a comparatively high drawing level while a lower drawing level is selected with respect to the background. Also, algorithms from different makers may be selected by considering the characteristics thereof. For example, an algorithm from a maker A is used for expression of a tree while an algorithm from a maker B is used for expression of smoke.

In step 220, the customer forms a CG image at the terminal 14 by the CG algorithm at the selected particular level. In step 230, the customer transfers data on editing or the image at the time of forming of the CG image or the set of the image editing data and attached data to the laboratory. In step 240, an image to be printed is formed in the laboratory by processing all the components and performing special-effect processing at the maximum drawing performance level (strictly speaking, an optimum level according to the print size). In step 250, the printer 18 outputs a print of the thus-processed image.

In this embodiment, as described above, it is not necessary for the customer to form the entire image at the same level, and the customer can separately express a portion that he or she wishes to express with accuracy and a portion that may be lower in image quality in his or her design, thus efficiently varying the expression.

In each of the above-described embodiments, the customer can select a point of compromise between the processing speed and the power of expression according to the ability of his or her own terminal, so that the degree of image forming freedom is high. Since on the laboratory side image data to be printed is formed by performing image processing at the highest level, a print of the optimized quality can be finally obtained.

It is obvious that, in any of the first and second embodiments of the invention as stated above, the CG image formed by image processing operation utilizing CG may, apart from being output as a print P from the printer 18, be formed as an image to be displayed and then displayed on the display 20 connected to the host computer 12 or the display 30 of the terminal 14, or alternatively, the data on the formed CG image as above may be recorded on a specified recording medium RM with the driver 22 or may be, via the communication network 16, sent back to the customer's terminal 14, or transferred to any other destination as designated by the customer or to the third person, or delivered to the third person or a specified delivery address.

In the examples as stated above, the customer's terminal 14 is used as a first image processor where a CG image is easily and freely formed in accordance with the performance of the processor by using the CG software of a specified drawing level and the host computer 12 connected with the customer's terminal 14 via the communication network 16 is used as a second image processor where a high-quality output CG image is formed by using the CG software of the drawing level higher than that of the CG software used on the side of the terminal 14. However, the present invention is not limited to these examples. The CG image processing with a CG software of a different drawing level may be performed by the first image processor where the CG image has been formed, the processor such as the customer's terminal and a personal computer (hereinafter referred to as “PC”) on the customer's side, or performed in a sharing manner by a plurality of PCs connected with one another via the communication network 16.

At first described is the case where the CG image processing with a CG software of a different drawing level is performed by the customer's PC in the image processing system according to the fourth aspect of the invention.

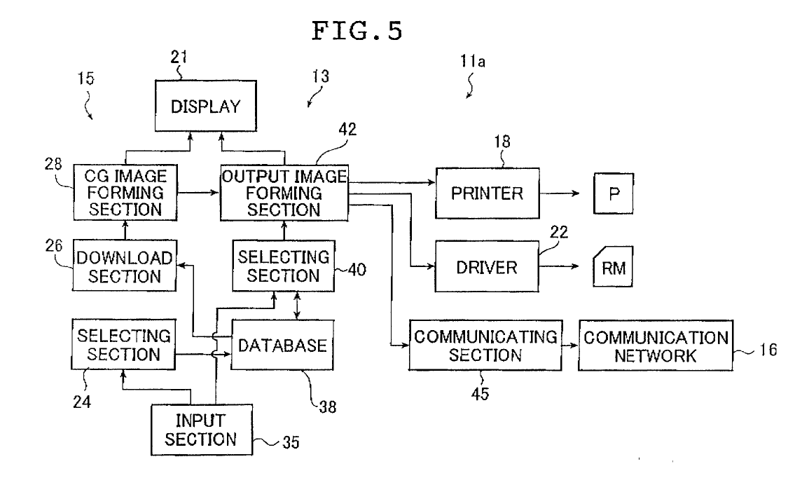

FIG. 5 shows a PC 11a constituting an image processing system of the third embodiment of the invention.

Since the PC 11a shown in FIG. 5 as the image processing system may be regarded as the host computer 12 and the terminal 14 of the image processing system 10 shown in FIG. 1 integrated with each other, like components are denoted by like reference characters and the explanation thereof omitted.

The PC 11a shown in FIG. 5 comprises a first image processing section 15 provided with a selecting section 24, a download section 26 and a CG image forming section 28; a second image processing section 13 provided with a database 38, a selecting section 40 and an output image forming section 42; a printer 18; a display 21; driver 22; an input section 35; and a communicating section 45. For simplicity, a CPU is not shown.

The first and second image processing sections 15 and 13 correspond to the terminal 14 and the host computer 12 shown in FIG. 1 respectively. The input section 35 possesses functions of both input sections 34 and 46 shown in FIG. 1 and the display 21 possesses functions of both displays 20 and 30 shown in FIG. 1.

In the PC 11a, the selecting section 24 directly accesses the database 38 and selects the CG software of a specified drawing level and the download section 26 functions as the reading section for reading the selected CG software of a specified drawing level from the database 38 directly and stores the read CG software in its inner memory. The output image forming section 42 receives the image editing data obtained upon forming of CG images and its annex data from the CG image forming section 28 directly and forms an output CG image with higher-quality by using the CG software of the higher drawing level.

The communicating section 45 possesses a function to deliver the output image data on the high-quality CG image formed by the output image forming section 42 to the communication network 16.

In the PC 11a as the image processing system constituted as described above, it is possible to process a CG image by using a CG software of a different drawing level.

For example, a CG image initially formed may be edited with the CG software of a specified drawing level, e.g., a low drawing level, and the CG image processing with the CG software of the drawing level of upper grade, e.g., a high drawing level, may be performed at another point of time. Further, the CG image processing at a high drawing level may be performed on the background subjected to the CG image processing at a low drawing level.

Although not shown, to the PC 11a as described above may be connected the host computer 12 or the terminal 14 shown in FIG. 1 or both.

Next described is the case where the CG image processing with the software of a different drawing level is performed in a sharing manner by a plurality of PCs connected with one another via the communication network 16.

FIG. 6 shows an image processing system 11b of the fourth embodiment of the invention that is constituted of a plurality of PCs connected with one another via the communication network.

The image processing system 11b shown in FIG. 6 is constituted such that a plurality of PCs 17 are connected with one another via the communication network 16 to one group as a whole.

The PCs 17 may be the same with or different from one another, as long as they are capable of constituting one group as a whole. For example, the PC 17 may be the PC 11a shown in FIG. 5, the terminal 14 of the image processing system 10 shown in FIG. 1, the host computer 12 of the image processing system 10 shown in FIG. 1, or any other PC possessing functions of such PCs.

In the image processing system 11b shown in FIG. 6, each of a plurality of PCs 17 constituting one group is capable of executing the CG software having a specified algorithm and a specified drawing level selected from a plurality of algorithms and a plurality of drawing levels of the CG software, which algorithm and drawing level are different from those of the CG software executed by other PCs 17. Thus, a plurality of PCs 17 of the group individually execute the CG software having a different algorithm and a different drawing level and share the CG image processing and CG image forming operations.

In other words, in the image processing system 11b of the example shown, the CG image processing at a low drawing level is performed by at least one of a plurality of PCs 17 and the CG image processing at a high drawing level is performed by at least one of other PCs 17.

The present invention is not limited to the fact that the CG image processing at a high drawing level is always executed by specified or fixed PCs 17, nor is such a fact needed.

Accordingly, in the present invention, it is preferable to suitably distribute the CG image processing at a high drawing level depending on the processing capability or the operating state of the PCs 17.

For this reason, it is preferable to provide a dedicated server for control which exclusively monitors the operating state or the loading state of PCs 17 constituting one group in the image processing system 11b and distributes the CG image processing at various drawing levels or any other CG image processing. Such a dedicated server for control makes it possible to automatically select the PCs 17 in the group and distribute the CG image processing at a high drawing level to them so as to most quickly obtain the result of the CG image processing at a high drawing level (that is, to most quickly finish such processing).

For example, a CG image is edited by A-machine 17a which is a member of the PC 17 group, whereas the CG image processing at a high drawing level performed by B-machine 17b. In the course of the processing at a high level by B-machine 17b, A-machine 17a finishes editing of the CG image and is then ready to edit a next CG image. It should be noted that the processing at a high level is not necessarily distributed to B-machine 17b next time also.

According to the present invention, in the image processing system 11b shown in FIG. 6, it is not inevitable to suitably distribute the CG image processing at a high drawing level depending on the processing capability or the operating state of PCs 17. It may be also possible to previously set in the image editing data or as processing conditions which of a plurality of PCs 17 should perform the CG image processing with the CG software having a specified algorithm and a specified drawing level selected from among various algorithms and various drawing levels of the CG software or at what point of time such processing is to be performed.

In various embodiments as stated above, the CG image processing at a different drawing level is preferably performed at the output stage. For example, a CG image is edited at a low drawing level and the CG image processing at a high drawing level is performed when the image is output, that is, when a print P is output from the printer 18, when the output image data is recorded on a recording medium RM with the driver 22, or when the output image data is transferred (delivered) via the communication network 16. Further, the CG image processing at a high drawing level may be performed upon image outputting on the side of the main frame PC or the print server.

The image processing method and system using the computer graphics in the first to fourth aspects of the present invention are basically arranged as described above.

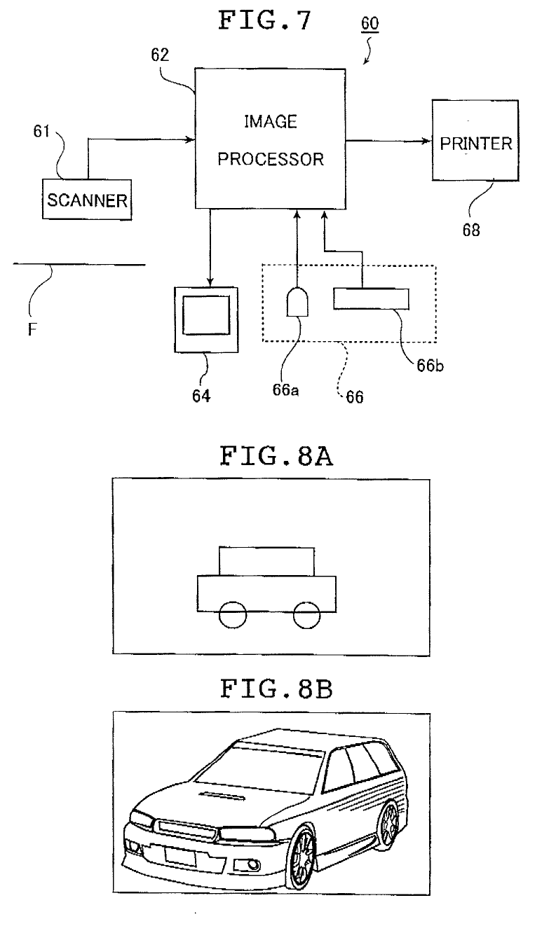

In the following, the image processing method according to the fifth and sixth aspects of the invention is described with reference to FIGS. 7 through 11B.

A fifth embodiment of the present invention will be described. The method in the fifth embodiment forms a high-quality computer graphics image from a hand-drawn image in such a manner that an image formed as a roughly hand-drawn simple figure is read to extract a comparative simple figure existing in the image, and the figure is replaced with a corresponding computer graphics image. This method is applied to a process in which a hand-drawn image brought to a laboratory by a customer is read with a scanner in the laboratory and is replaced with a computer graphics image, which is output as a print to be delivered to the customer.

FIG. 7 schematically shows the configuration of a digital photoprinter including an image processor for carrying out the image processing method of the present invention.

The digital photoprinter 60 shown in FIG. 7 is constituted mostly by a scanner 61 which reads a hand-drawn image F, an image processor 62 which forms a high-quality output image from the read image by using computer graphics, a monitor 64 which is connected to the image processor 62, and which displays an image, an operating system 66 (mouse 66a, a keyboard 66b) for operating the entire digital photoprinter as well as the image processor 62, and a printer 68 which outputs a print of an image to be output.

A hand-drawn image read by the scanner 61 is supplied to the image processor 62. The image processor 62 replaces the supplied hand-drawn image with a computer graphics image. To smoothly perform this replacement, the image processor 62 registers and holds, in a data base, data on simple line-drawn figures and images corresponding to the figures and expressed with improved quality.

Replacement of a hand-drawn image with a computer graphics image is performed in such a manner that a registered image is extracted by, for example, pattern matching or the like from the hand-drawn image, and the computer graphics image corresponding to the extracted image is selected from the data base, and the computer graphics image is combined with the hand-drawn image by being substituted for the hand-drawn image by taking into the consideration the position and size of the extracted image in the hand-drawn image.

After completing the replacement of all the images in the hand-drawn image, predetermined image processing is subjected thereto to prepare an image to be output. The image to be output may be output from the printer 68 as an image to be printed, or output to a medium such as a file as a display image.

The operation of this embodiment will now be described.

First, a customer makes a simple sketch of an image which he or she wishes to output as a print etc. It is not necessary to finely make this sketch. For the purpose of enabling anyone to easily form a computer graphics image, the hand-drawn image F to be read by the scanner 61 may be a comparatively simple line-drawn figure, only depicted as an outline, may suffice. It is preferable that, when the customer makes this sketch, a list of figures registered in the data base in advance should be provided for the customer. For example, as a figure registered as an image of a motor vehicle, a combination of a rectangle and two circles on the lower side of the rectangle may be provided. When a hand-drawn image is formed by referring to the list, it is replaced with, for example, a computer graphics image of an ordinary motor vehicle to form an image to be output. For example, if the customer wishes to form an image of a motor vehicle, he or she may depict a picture such as shown in FIG. 8A. In this case, a plurality of registered motor vehicle figures may be referred to; figures easily discriminable in correspondence with several types of motor vehicle may be prepared to enable an output image to represent a particular type of motor vehicle more closely. When the customer brings the thus-formed hand-drawn image to the laboratory, the hand-drawn image is read with the scanner 61 in the laboratory.

For example, when a hand-drawn image F such as shown in FIG. 8A is read with the scanner 61, the read hand-drawn image is supplied to the image processor 62.

The image processor 62 decomposes contour lines and other lines of the read hand-drawn image into simpler figures to extract figures corresponding to those registered in the data base in advance. These figures are simple figures, for example, a circle, an ellipse, a rectangle, and a spiral, and are simple figures representing a flower, a motor vehicle, a house, etc. Extraction of such figures is performed by, for example, pattern matching or geometrical figure tracing proposed by the applicant of the present invention as disclosed in Japanese Patent Laid-open No. 11-200572.

Computer graphics images corresponding to the extracted registered figures are selected from the data base and are substituted for the corresponding figures in the hand-drawn image to be combined. For example, the figure shown in FIG. 8A is replaced with a computer graphics image of a motor vehicle to form an image such as shown in FIG. 8B. In this case, a plurality of computer graphics images corresponding to each figure may be found. Several 3D images suitable for the pursuit of reality, 3D images for animation, and/or 2D images may be prepared, and one of such images may be selected. The selected image may be processed to have gradations or to be shaded with respect to the color tone of a picture portion.

The registered images may include, as well as computer graphics images, photographic images actually photographed, e.g., photographs of the faces of members of the customer's family and photographs of scenic sights such as Mt. Fuji.

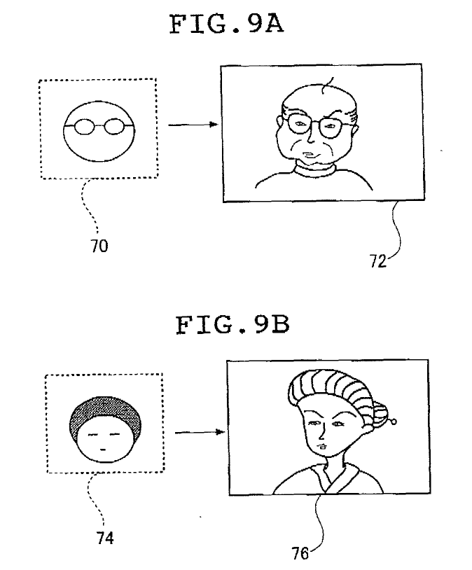

For example, simplified portraits may be registered in advance together with photographs of the corresponding family member's faces. If a portrait 70 of the father in the family, such as shown in FIG. 9A, is extracted from the hand-drawn image, the extracted image may be replaced with a photograph 72 of the father's face If a portrait 74 of the mother in the family, such as shown in FIG. 9B, is extracted from the hand-drawn image, the extracted image may be replaced with a photograph 76 of the mother's face. The photograph to be substituted in this case may be a photograph of the full length or the like other than a photograph of the face.

A portion of the hand-drawn image which cannot be decomposed into simple figures or a portion having no match in the registered figures may be directly copied in output image data. Alternatively, a portion left after extraction of figures may be neatly painted or, if it is a background, it may be replaced with wallpaper, thereby improving the image quality.

If an image thus formed to be output is an image to be printed, it is supplied to the printer 68 to be output as a print from the printer 68. The output image may be output as a poster-like large print as well as a photographic print, and may be output to a file storage medium or the like as an image to be displayed.

In this embodiment, as described above, simple figures are extracted from a hand-drawn image and replaced with a computer graphics image or the like, thereby enabling even a person weak in handling a computer or the like to easily form an image using computer graphics image.

A sixth embodiment of the present invention will be described below.

The sixth embodiment is arranged to further facilitate forming of a computer graphics image in comparison with the fifth embodiment.

In this embodiment, the area occupied by each of objects in a hand-drawn image and the size of the object are indicated by being encircled with a closed curve forming a circle or an ellipse, and the object is represented by letters, a simple pictorial symbol or the like.

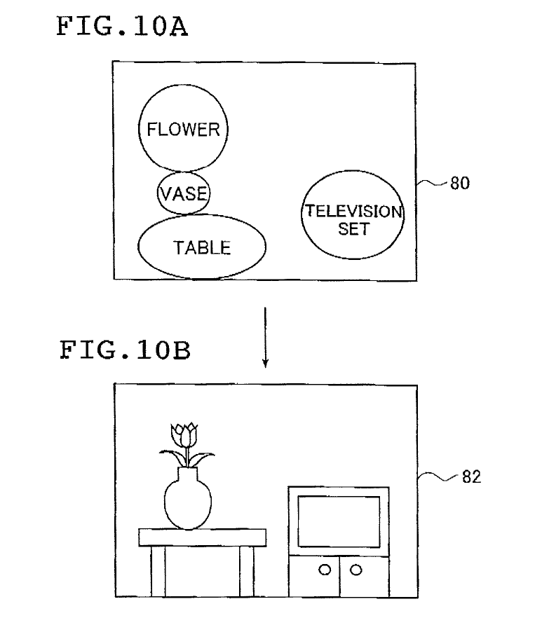

In a case where a picture is to be depicted to contain an image of a vase with flowers put on the table and an image of a television set positioned by the side of a table, a hand-drawn image 80 is formed in such a manner that, as shown in FIG. 10A, the area which corresponds to the position of each object, and which coincides generally with the size of the object is encircled with a closed curve forming a circle or the like, and letters or the like are written within the closed curve to indicate the existence of the object. The hand-drawn image 80 thus formed is read with the scanner 61, and the image processor 62 extracts each closed curve. With respect to this embodiment, it is assumed that such a closed curve represents the existence of an object. The kind of object indicated by the closed curve is determined by recognizing letters shown within the closed curve. The object represented by each closed curve is replaced with a registered computer graphics image, thereby forming a computer graphics image 82 such as shown in FIG. 10B.

In this case, not only a name of an object, e.g., “flower” but also the kind of the flower is designated, and the object is replaced with an image of the corresponding kind of flower. With respect to other objects, more specific characters or the like of each object may be designated.

Within the area encircled with each closed curve, a simple pictorial symbol may be entered as well as letters. It is preferable that the denotation of the pictorial symbol should be determined and registered in advance, and that a list of symbols prepared in this manner should be provided. In this manner, forming of a hand-drawn image and identification after reading of the image can be facilitated.

In the image shown in FIG. 10B, the color of each object, the direction of rays falling on the object, the state of shading, processing for the background, etc., may be designated to enable corresponding processes to be performed to form an image with improved reality.

A seventh embodiment of the present invention will be described.

This embodiment is generally the same as the above-described sixth embodiment but differs in that while the hand-drawn image in the sixth embodiment is a font view, a hand-drawn image in this embodiment is a plan view (diagram showing a state viewed from above).

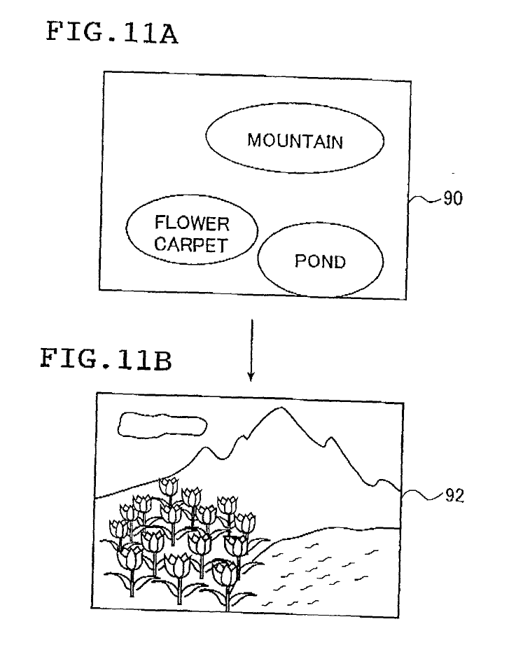

In a hand-drawn image in this embodiment, as shown in FIG. 11A, the placement of objects as viewed from above is indicated. That is, in the case of a hand-drawn image 90 shown in FIG. 11A, a composition is expressed such that a flower carpet extends by a pond, and there is a mountain beyond the flower carpet and the pond. This embodiment is assumed to have a mode in which a picture viewed from above as shown in a plan view is expressed as a picture as viewed in a substantially horizontal direction. When this mode is selected, the hand-drawn image is treated as a plan view.

When the hand-drawn image 90 is read with the scanner 61 after this mode has been selected, the image processor 62 extracts the pond, the flower carpet, and the mountain respectively encircled with closed curves, replaces them with registered computer graphics images, and expresses these images in a composition shown as a front view, thereby forming a computer graphics image 92 such as shown in FIG. 11B.

The arrangement may be such that the kind of flowers in the flower carpet can be designated, and images of particular mountains may be registered to enable designation of the name of a particular mountain.

Another mode may be provided in which, like an aerial photograph, a composition viewed from above is expressed in a state of being viewed in the same direction without being replaced with a composition viewed in a horizontal direction.

An eighth embodiment of the present invention will be described.

In the eighth embodiment, the degree of freedom of replacement of a hand-drawn image with a computer graphics image is increased to add an entertainment effect.

That is, in this embodiment, objects are roughly designated in a hand-drawn image while a multiplicity of computer graphics images are provided. When computer graphics images are selected, some images are randomly selected to the multiplicity of computer graphics images, thereby increasing enjoyment of anticipation of an image formation result.

For example, with respect to designation of “flower”, images of flowers, e.g., those of tulip, rose, and orchid varied in color may be prepared and registered. The images of some of the registered flowers in season may be selected by considering the season in which an image to be output is formed. For example, in the above-described embodiments, the flowers are changed with respect to the seasons and the colors of the mountain, the pond and the sky are also changed in accordance with the season to increase the variety of output images.

Also, with respect to designation of, for example, “airplane”, images of different models and exteriors of airplanes belonging to different airlines may be prepared and registered.

Images registered as described above may be images obtained by actual photography or images formed by computer graphics. Computer graphics images of airplanes and motor vehicles may include images representing imaginary models not existing actually.

The laboratory may respond special requests from customers. For example, customer codes and images according to preferences of the corresponding customers may be registered in advance, and processing may be performed so as to always select images of orchids in response to designation of “flower” by one particular customer.

A ninth embodiment of the present invention will be described.

In each of the above-described embodiments, a customer brings a hand-drawn image to a laboratory and orders a print of the image. Thereafter, in the laboratory, image processing is fully automatically performed by using computer graphics on the basis of the hand-drawn image brought by the customer, and a high-quality print is thereby output and delivered to the customer. In contrast, in this embodiment, a customer and a laboratory exchange information with each other until image printing is performed, thereby enabling printing according to the customer's need.

First, the customer forms a hand-drawn image in the same manner as that in the above-described embodiments. In this embodiment, the customer transmits the hand-drawn image to the laboratory with facsimile machines. The present invention is intended to enable even a person weak in handling a personal computer or the like to form a computer graphics image without assumption that a customer will form a hand-drawn image by using a personal computer and transmit the image to the laboratory by communication through the personal computer or the like. Needless to say, if a customer can use such means, the laboratory may accept data transmitted in such a manner.

On the laboratory side, the hand-drawn image transmitted from the customer with a facsimile machine is read with a scanner. Registered figures are extracted from the hand-drawn image, and computer graphics are combined with the read image by being substituted for the extracted figures to form a computer graphics image to be output. This process is the same as that in the above-described embodiments. The synthesized computer graphics image is transmitted from the laboratory to the customer with the facsimile machines. If the customer checking the formed computer graphics image is not satisfied with it, he or she again transmits the necessary information to the laboratory. Exchange of information is repeated until the customer gives his or her OK. When the customer gives his or her OK, a final print is output from the printer on the laboratory side.

When computer graphics images, etc., are registered in the laboratory data base in each of the above-described embodiments, data on each computer graphics image is registered in one of the following modes:

(mode 1) in which the entire data on the complete computer graphics image is registered, and

(mode 2) in which only the algorithm and editing data such as set parameters for forming the computer graphics image are registered.

In the case of registration in the mode 1, since the complete data is registered, only loading of this data may suffice for forming the computer graphics image, so that the computer processing time is reduced. On the other hand, the amount of data stored in the data base becomes considerably large.

In the case of registration in the mode 2, the amount of data stored in the data base is reduced but it is necessary to increase the throughput of the computer because the computer graphics forming algorithm is started to form the computer graphics image.

After all, it is preferable that computer graphics images provided as common-pattern images or images frequently used should be registered in the above-described mode 1, and that, if a unique composition or particularly high image qualities are required at a request from a customer, a computer graphics image should be newly formed from editing data registered in the above-described mode 2.

Thus, computer graphics images can be formed efficiently if the above-described modes are changed and properly used according to the throughput of the data base and the computer and according the kinds of requests from customers.

In the fifth to eighth embodiments of the invention, as described above in detail, a customer only depicts a simple hand-drawn image and necessary processing is automatically performed on the laboratory side to form a computer graphics image, so that even a person weak in handling a computer or the like or a child can easily use computer graphics. Also, image data is processed at a request from the customer to output a print having higher image qualities.

The image processing method in the fifth and sixth aspects of the present invention is basically arranged as described above.

The image processing method and system using computer graphics in accordance with the present invention have been described with respect to various embodiments of the invention. However, the present invention is not limited to the above-described embodiments, and various modifications and changes of the described embodiments may be made without departing from the scope of the invention.

According to the first to fourth aspects of the present invention, a computer graphics image can be efficiently formed according to the performance of a terminal in possession of a customer, and a high-quality output image can be finally obtained.

According to the fifth and sixth aspects of the present invention, processing is automatically performed on the laboratory side on the basis of a simple hand-drawn image depicted by a customer to form a computer graphics image, so that even a person weak in handling a computer or the like or a child can easily form an image by using computer graphics.

What is claimed is:

1. An image processing method utilizing computer graphics in which an image at a higher drawing level is formed from a computer graphics image formed by computer graphics, said method comprising the steps of:
selecting a particular drawing level from a plurality of drawing levels set in advance for a computer graphics algorithm based on at least one of an amount of computation processing, an amount of data and a display resolution;
executing a process of forming the computer graphics image by said computer graphics algorithm at the thus selected particular drawing level; and
performing processing by said computer graphics algorithm at a higher drawing level than said particular drawing level which was selected from said plurality of drawing levels based on editing data in the process of forming said computer graphics image at said particular drawing level or based on said editing data and attached data thereby forming image data at said higher drawing level.

2. The image processing method according to claim 1, wherein said image at the higher drawing level is an image to be printed or an image to be displayed, and said image data at the higher drawing level is print image data or display image data.

3. The image processing method according to claim 1, wherein said image at the higher drawing level is an output image, said image data at the higher drawing level is output image data, and said processing by said computer graphics algorithm at the higher drawing level is performed in a process of outputting.

4. The image processing method according to claim 1, wherein when said computer graphics image is formed, said particular drawing level is selected from said plurality of drawing levels for each image component in an imaged scene or for each processing operation performed for producing a specified particular effect on said computer graphics image.

5. The image processing method according to claim 1, wherein a plurality of computer graphics algorithms are further prepared, and a particular algorithm is selected from said plurality of computer graphics algorithms based on at least one of said amount of computation processing, said amount of data and said display resolution, and for the thus selected particular algorithm, said particular drawing level is selected from said plurality of drawing levels.

6. The image processing method according to claim 5, wherein when said computer graphics image is formed, said particular algorithm is selected from said plurality of computer graphics algorithms for each image component in an imaged scene or for each processing operation performed for producing a specified particular effect on said computer graphics image.

7. The image processing method according to claim 1, wherein the process of forming the computer graphics image at the particular drawing level is performed in a first image processor, whereas the processing by said computer graphics algorithm at the higher drawing level is performed with a different timing in a second image processor different from said first image processor.

8. The image processing method according to claim 7, wherein said first image processor is a personal computer and said second image processor is a host computer connected to the personal computer through a communication network.

9. The image processing method according to claim 1, wherein the process of forming the computer graphics image at the particular drawing level is performed in an image processor and the processing by said computer graphics algorithm at the higher drawing level is performed in the same image processor.

10. The image processing method according to claim 9, wherein said image processor is a personal computer.

11. The image processing method according to claim 1, wherein processing operations at different drawing levels including the process of forming the computer graphics image at the particular drawing level and the processing by said computer graphics algorithm at the higher drawing level are performed by sharing among a plurality of image processors interconnected through a communication network.

12. The image processing method according to claim 11, wherein said plurality of image processors are personal computers.

13. The image processing method according to claim 17, wherein an image processor to be selected from said plurality of image processors for performing a processing operation at each of said different drawing levels and a timing applied for performing said processing operation are set in advance to said editing data or as a processing condition.

14. An image processing system utilizing computer graphics comprising:
a host computer; and
an image processor which is connected to the host computer through a communication network and forms a computer graphics image for forming an output image in said host computer, said image processor including:
a selecting section for selecting for a computer graphics software a particular algorithm and a particular drawing level from a plurality of algorithms and a plurality of drawing levels set in advance in said host computer based on at least one of an amount of computation processing, an amount of data and a display resolution;
a download section for downloading the computer graphics software corresponding to the thus selected particular algorithm and drawing level from said host computer; and
an image forming section for forming said computer graphics image by using the thus downloaded computer graphics software;
wherein image editing data in a process of forming said computer graphics image or said image editing data and data attached thereto are transmitted to said host computer through said communication network.

15. An image processing system utilizing computer graphics comprising:
an image processor; and
a host computer which forms an output image based on a computer graphics image formed in said image processor connected to said host computer through a communication network;
said host computer including:
a selecting section for selecting a computer graphics software at a higher drawing level than in a computer graphics software used by said image processor to form said computer graphics image; and
a section for forming said output image by the selected computer graphics software at the higher drawing level by using image editing data when said computer graphics image was formed in said image processor or the image editing data and data attached thereto, which have been received from said image processor through said communication network;
wherein the output image is output as a print, recorded on a predetermined recording medium, or transmitted through said communication network.

16. An image processing system utilizing computer graphics comprising:
a first image processor for forming a computer graphics image; and
a second image processor for forming an output image based on said computer graphics image formed in said first image processor;
wherein said first image processor includes:
a selecting section for selecting for a computer graphics software a particular algorithm and a particular drawing level from a plurality of algorithms and a plurality of drawing levels set in advance in said second image processor based on at least one of an amount of computation processing, an amount of data and a display resolution; and
a computer graphics image forming section for forming the computer graphics image by using the computer graphics software corresponding to the thus selected particular algorithm and drawing level, whereas said second image processor includes:
a selecting section for selecting a computer graphics software at a higher drawing level than in said computer graphics software used in said first image processor to form said computer graphics image; and
a section for forming said output image by the thus selected computer graphics software at the higher drawing level by using image editing data when said computer graphics image was formed in said first image processor or the image editing data and data attached thereto; and
wherein the output image is output as a print, recorded on a predetermined recording medium, or transmitted through a communication network.

17. The image processing system according to claim 16,
wherein said first image processor is connected to said second image processor through the communication network;
wherein said first image processor further includes a download section for downloading the selected computer graphics software from said second image processor;
wherein the computer graphics image forming section forms said computer graphics image by using said computer graphics software downloaded by said download section;
wherein the image editing data when said computer graphics image was formed or the image editing data and the data attached thereto are transmitted to said second image processor through said communication network; and
wherein said second image processor receives said image editing data when said computer graphics image was formed or the image editing data and the data attached thereto from said first image processor through said communication network.

18. The image processing system according to claim 17, wherein said second image processor is a host computer connected to said first image processor through said communication network.

19. The image processing system according to claim 16, wherein one image processor functions as said first image processor and said second image processor.

20. The image processing system according to claim 16, wherein said first image processor is a personal computer.

21. The image processing system according to claim 16,
wherein said first image processor and said second image processor include a plurality of personal computers which execute said computer graphics software in different algorithms included in said plurality of algorithms and at different drawing levels included in said plurality of drawing levels;
wherein the plurality of personal computers are interconnected by the communication network, and
wherein said computer graphics software is shared for said different algorithms and said different drawing levels among said plurality of personal computers and executed.

22. The image processing system according to claim 21, wherein a personal computer to be selected from the plurality of personal computers for executing said computer graphics software in each of said different algorithms and at each of said different drawing levels, and a timing applied for executing said computer graphics software are set in advance to said editing data or as a processing condition.

23. An image processing method comprising the steps of:
reading a hand-drawn image;
extracting from the thus read hand-drawn image a figure having a shape registered in advance; and
substituting an image registered in advance and corresponding to the thus extracted figure for the extracted figure in the read hand-drawn image thereby forming an output image.

24. The image processing method according to claim 23, wherein the image registered in advance is a computer graphics image or a photographic image.

25. An image processing method having at least one mode corresponding to a figure having a shape registered in advance which is selected from:
a mode in which a complete computer graphics image is registered in advance;
a mode in which computer graphics forming algorithms and setting parameter editing data are registered in advance; and
a mode in which said complete image and said editing data are selectively registered, said method comprising the steps of:
reading a hand-drawn image;
extracting from the thus read hand-drawn image the figure having the shape registered in advance; and
forming an output image by substituting for the extracted figure the complete image registered in advance and corresponding to the extracted figure, or by forming a computer graphics image by using said editing data registered in advance and corresponding to the extracted figure and by substituting the formed computer graphics image for the extracted figure according to one of said modes.

26. The image processing method according to claim 25, wherein switching between the mode for registering the complete image and the mode for registering the editing data is performed according to a frequency of use of a registered image, or a composition or an image quality of the output image.
